(19) United States
(12) Patent Application Publication
(10) Pub. No.: US 2009/0043743 A1
(43) Pub. Date: Feb. 12, 2009

(54) PRIVACY INFORMATION REPORTING SYSTEMS WITH BROAD SEARCH SCOPE AND INTEGRATION

(76) Inventor: Harold H. Kraft, Arlington, VA (US)

Correspondence Address: MILES & STOCKBRIDGE PC, 1751 PINNACLE DRIVE, SUITE 500, MCLEAN, VA, 22102-3833, US

(21) Appl. No.: 12/253,661

(22) Filed: Oct. 17, 2008

Related U.S. Application Data
(62) Division of application No. 11/163,205, filed on Oct. 10, 2005, now abandoned.
(60) Provisional application No. 60/596,399, filed on Sep. 20, 2005.
(60) Provisional application No. 60/595,283, filed on Jun. 20, 2005.

(51) Int. Cl. G06F 17/30; G06F 7/10; G06F 21/00

(52) U.S. Cl. 707/3; 707/10; 726/4; 707/E17.014; 707/E17.01

(57) ABSTRACT

A system for providing background check information to consumers diversifies a search vector by iteratively searching databases to obtain comprehensive identifying information while eliminating redundancies. Fuzzy expansion operators based on phonetics, misspellings, and other factors may be employed. The self-background check is intended to be used by consumers to safeguard against identify theft.

### CROSS REFERENCE TO RELATED APPLICATIONS

The present application is a divisional application of U.S. Ser. No. 11/163,205, filed Oct. 10, 2005, now pending, which claims priority to U.S. Provisional 60/596,399, filed Sep. 20, 2005, now expired, and U.S. Provisional 60/595,283, filed Jun. 20, 2005, now expired.

### BACKGROUND

Background checks are a staple tool used by prospective employers, private and public investigators and detective organizations, prospective spouses, and prospective creditors. Many services are available to generate reports providing information such as criminal background and financial credit-worthiness. More recently, the need for additional information such as verification of institutional credentials has been identified and mechanisms for providing such information proposed. The World Wide Web has spawned a variety of services allowing individuals and organizations to search for specific information about other parties, for example a family could perform a criminal background check on a prospective nanny or find out the owner of vehicle based on the license plate of vehicle identification number.

In PCT Publication No. W02005026899 for “CANDIDATE-INITIATED BACKGROUND CHECK AND VERIFICATION,” a system is described in which a candidate for a relationship, such an employment relationship, can initiate a background check of himself, such as would otherwise be performed by the prospective employer. The report obtained is made available to the prospective employer thereby allowing the candidate to eliminate the time and expense burden for the employer or other decision-maker. The ability for the candidate to provide annotations to the records of the candidate's data is provided. Searches may be done on address history, civil records, criminal records, and a social security number verification. A similar system is also described in US Patent Publication No. US2004/088173 for “INTERACTIVE, CERTIFIED BACKGROUND CHECK BUSINESS METHOD.”

In U.S. Pat. No. 6,714,944 for “SYSTEM AND METHOD FOR AUTHENTICATING AND REGISTERING PERSONAL BACKGROUND DATA,” a system is described for creating a database in which information about a candidate is entered into a database and third parties with authority to verify the information can provide such verification information in the database. Then second parties, such as employers, can see not only the background information but the verification information from the third parties as well. So for example, the employer can see the degree and a verification token of the institution from which it came. Suitable mechanisms for authentication and authorization are described for generation of the database.

In addition, for years, consumers have been encouraged to check their credit reports for errors and discrepancies. But credit reports are no longer enough. Background data collected on every citizen extends far beyond bank and credit company information, and can affect a consumer's entire life-from a consumer's ability to get a job, to renting or buying a house or an apartment, to obtaining health or property insurance. Consumers need a way to check for incorrect information in their reports in order to ensure they are not the subject of identity confusion. Even more important, with identity theft one of the fastest growing crimes in America, it is even more important to ensure consumers are not the subject of identity theft. Information on each consumer may be compromised by identity thieves who not only open bank or credit card accounts, but also use a consumer's identity to rent or buy property, commit crimes or misdemeanors, or obtain employment in a consumer's name. This information does not appear in credit reports.

Comprehensive reporting systems of the prior art are generally geared to the needs of businesses, addressing their needs for managing their risk. In particular contexts, the prior art reflects a need for an awareness of background information that may be used by third parties making a decision affecting, for example a job applicant's future.

### SUMMARY

A system for providing background check information to consumers may diversify a search vector by iteratively searching databases to obtain comprehensive identifying information while eliminating redundancies. Fuzzy expansion operators based on phonetics, misspellings, and other factors may be employed. The self-background check is intended to be used by consumers to safeguard against identify theft.

Consumers need to manage and mitigate different and additional kinds of risk, for example, the risk of corrupt, missing, or information erroneously attached to their identities. The present inventions address the needs of consumers to allow them to perform a comprehensive check of background information which can provide not only the ability to avoid confusion by third parties, such as prospective employers, but also an indication of fraudulent use of personal information such as would attend an instance of identify theft. Armed with such information, consumers can takes steps to protect their identity from further exploitation, mitigate future risk, and repair damage done by identity theft.

The inventions provide, in embodiments, a Public Information Profile (PIP), which is a detailed summary of the information available to others about individuals. In embodiments, a system may sift through many, (e.g., 10 billion records) housed and administered by one or more data aggregators and culled by them from various public sources. In embodiments, a report is generated from these records using a networked architecture and delivered to a user (the subject of the search) via a terminal.

Data sources that may be queried, either directly or through intermediate aggregators, include, for a few examples: Federal, State and County records Financial records like bankruptcies, liens and judgments Property ownership records Government-issued and other licenses Law enforcement records on felony and misdemeanor convictions UCC (Uniform Commercial Code) records that reveal the availability of assets for attachment or seizure, and the financial relationship between an individual and other entities.

The system assembles this information into a single document (the PIP) which may be delivered online as an html or pdf type document or printed and mailed to a user, for example.

Various means of authentication may be provided to prevent someone other than the particular subject of the research from generating that individual's PIP. A preferred mechanism uses identification information about the user and queries one or more data sources for further information. Then the system generates a quiz based on this information to verify the contents of this further information. For example, the quiz may ask the user to indicate which of a list of addresses was a former residence of the user. The question can be generated as a multiple choice question with “none of the above” being a choice, to make it more difficult. Other kinds of questions can be based on the identity of a mortgage company, criminal records, or any of the information the system accesses.

In embodiments, the PIP is generated from a data aggregator, which is a secondary source the collects information from primary sources and makes it available without having to go to the many primary sources. This is done for speed and convenience and aggregators charge a fee for this. In the embodiments, the system may generate a PIP which includes a form to accept data from a user indicating that certain data is questionable or indicates misinformation about the person or that some specific piece of data is missing. For example, a criminal conviction comes up on the report or a piece of real estate the user formerly owned fails to show up.

In these embodiments, the user feedback indicating a question about the report contents may be used to generate a further query to primary sources. Many problems can occur in the uptake of data from primary sources to the secondary aggregators used to generate the reports. So a query of the primary sources may indicate the source of the erroneous or missing data as being due to an error in the secondary data source. Since the primary is more authoritative, the correct primary data may be delivered to the user in a second report which juxtaposes the primary and secondary data. The second report may include the user's own comments in juxtaposition, for example, explanations for certain events with citations to supporting data may be entered and included in the report.

In alternative embodiments, rather than querying primary sources in response to a user's indication of questionable data, the primary sources may be queried based on a schedule of sensitivity, degree of risk imposed by errors, or likelihood of errors. For example, if the first query of the secondary source turns up criminal records that are closely associated with the user, for example based on an identical name, the primary sources in the associated jurisdiction may be queried to provide verification or highlight a discrepancy in the data.

Another alternative may be to limit the scope of search of primary sources based on “bread crumbs” left by the user throughout his life. For example, the primary sources for each state the user has lived in (as indicated by the query result of the secondary source) may automatically be queried. Yet another alternative is to offer the user a form to ensure that the data obtained and used to query the primary sources is complete. For example, the user may be shown a list of states in which the user appears to have lived based on the first query of the secondary source and asked if the list of states is complete. The user may then enter additional states as needed and the primary sources queried based on the complete list.

Yet another alternative may be to query both secondary and primary sources. This may have value for a user if the secondary source is one that is routinely used by third parties. Discrepancies between the primary and sources can provide the user with information that may help him answer or anticipate problems arising from third party queries of the secondary source. For example, if the user applies for a job and the prospective employer queries the secondary source, the user may be forearmed with an answer to any questions arising about his background. For example, the user may note on his application that there is corrupt data in the secondary source regarding his criminal history. Note that the alternatives identified above may be used alone or in combination.

The results of the primary search may be considered more authoritative since any discrepancies may be the result of transcription errors, data corruption, or other process that distorts data aggregated from the primary source. A user concerned about misinformation being obtained and acted upon by an interested third party may be offered by the user to the third party in some form. For example, a certified report showing the report fleshed out with data from both the primary and secondary sources according to the above may be generated by the system.

According to additional embodiments, the second report, with primary as well as secondary data and also with user-entered annotations and citations, may be generated by the user and printed but it may also be generated by third parties using an online process. For example, the system may store the complete second report after querying the primary sources and adding user annotations. The report can be generated by the user or by a third party with the user's permission and under the user's control, for example, by providing the third party with a temporary username and password provided on request to the user by the system and providable by the user to the third party. The credibility of the report stems from the fact that it cannot be altered directly by the user, the owner of the system deriving much of its value from its integrity as well as the annotations and additional information provided by users.

Also, information for which there is a discrepancy between primary and secondary data may be submitted by the system operator to operators of the secondary source or sources. This information may be used to alter the secondary source data thereby to remove the discrepancy. Annotations and further citations submitted by the user through the system may also be transmitted by the operator of the system to the operator of the secondary source(s) for purposes of correction.

A user may subscribe to a service offered by the system, for example by paying a one-time fee or a periodic fee, which allows the user to obtain and recompile information. In addition, according to a similar subscription model, the user may receive periodic, or event-driven change reports which indicate changes in the content of the user's PIP. The change report may be delivered as full report with changes highlighted or as just a report indicating changes that have occurred. During the period of the subscription, the system may compile and keep a record of changes so that an historical record may be created and accessed and reviewed by the user. For example, the user may obtain change reports between any two dates.

Preferably PIP or associated information are provided to highlight data that are particularly sensitive or important and also to indicate the relevance of, or what to do about problems with, each item of the data in the PIP. The PIP may include, along with a detailed listing of findings, a narrative, automatically generated, which discusses the most salient features of the PIP. Such a narrative may be generated using template grammatical structures in a manner used by chatbots (chatterbots) for example, see U.S. Pat. No. 6,611,206, hereby incorporated by reference as if fully set forth in its entirety, herein. Also, preferably, PIPs will indicate what search criterion was used to retrieve the record. In querying databases, there is no one unique identifier of a person who is the subject of the search. The person's name, social security number, or other information may be used alone or in combination with other data. Also, close matches to the name may be used. A user reviewing his report may be interested to know how the record was associated with him and this may be indicated by the PIP overtly or conditionally, such as by a hyperlink button or mouse-over balloon text, for example.

According to an embodiment, the invention is a method of providing a report of public information, relating to an individual, to that individual, comprising: from at least a network server, transmitting a form with fields for obtaining identifying information, identifying said individual, to a client terminal, receiving at at least a network server from said client terminal, identifying information associated with said form fields, said identifying information substantially uniquely identifying said individual, at at least a network server, authenticating a requester at said client terminal to confirm that said requester is said individual, at at least a network server, querying a database with a first query based on part of said identifying information and retrieving a result, said result containing at least two pieces of information about individual, deriving a second query from said at least two pieces of information and querying said database and/or another database using said second query, retrieving a result of said second querying, generating a report with said results of said second querying, said results including at least real estate records.

According to another embodiment, the invention is a method of providing a report of public information, relating to an individual, to that individual, comprising: from at least a network server, transmitting a form with fields for obtaining identifying information, identifying said individual, to a client terminal, receiving at at least a network server from said client terminal, identifying information including a social security number, at at least a network server, authenticating a requester at said client terminal to confirm that said requester is said individual, at at least a network server, querying a first database with a first query including said social security number and retrieving at least two addresses corresponding to said individual, eliminating redundancies among said at least two addresses and generating a second query including non-redundant addresses such that records retrieved by said second query include records pertaining to all non-redundant addresses, performing a query with said second query and retrieving a second result, generating a report with said results of said second result, said second result including at least real estate records.

Various objects, features, aspects and advantages of the present invention will become more apparent from the following detailed description of preferred embodiments of the invention, along with the accompanying drawing.

### BRIEF DESCRIPTION OF DRAWINGS

FIG. 1 illustrates a network or Internet architecture for implementing various features of the present inventive embodiments.

FIG. 2A illustrates an embodiment in which a public information profile report may be generated from a secondary source, such as a data aggregator.

FIG. 2B illustrates an example of a public information profile report which may be generated according to inventive embodiments described in FIG. 2A and elsewhere in the specification.

FIG. 3 illustrates a quiz technique for authenticating a user.

FIG. 4 illustrates an embodiment in which a change report is generated from a user profile and a public information database.

FIG. 5 illustrates a system and method for generating an augmented public information profile report in which questionable information is fixed and/or annotated.

FIG. 6 shows a complete PIP illustrating an embodiment of a report form.

FIG. 7 shows a complete PIP illustrating an embodiment of a fix report.

FIG. 8 shows a portion of a PIP embodiment relating to real estate residences purchased.

FIG. 9 illustrates a portion of an embodiment of a list of data sources accessed.

FIG. 10 illustrates other information that may be included in a PIP.

FIG. 11 shows an example process for searching a database in which the search query is made broader by an iterative process that derives alternative search criteria.

FIG. 12 shows a process related to that of FIG. 11 for iteratively broadening search criteria until a target threshold number of records is reached.

FIG. 13 shows an embodiment of a portion of a public information profile (PIP) which summarizes the contents obtained.

FIG. 14 shows an embodiment of a portion of a public information profile (PIP) which provides links to different portions of the PIP.

FIG. 15 shows an embodiment of a portion of a public information profile (PIP) which provides information and link controls for assistance regarding certain elements of the PIP.

FIG. 16 shows an embodiment of another portion of the public information profile (PIP) which provides information and link controls for assistance regarding certain elements of the PIP.

FIGS. 17A and 17B show collapsed and expanded views of criteria used to show records obtained (a similar embodiment may be included as well to show information about the sources of the information).

FIGS. 18 and 19 illustrate a PIP format feature that helps users understand when discrepancies may arise between one or more data sources and how to cure them.

### DETAILED DESCRIPTION OF DRAWINGS

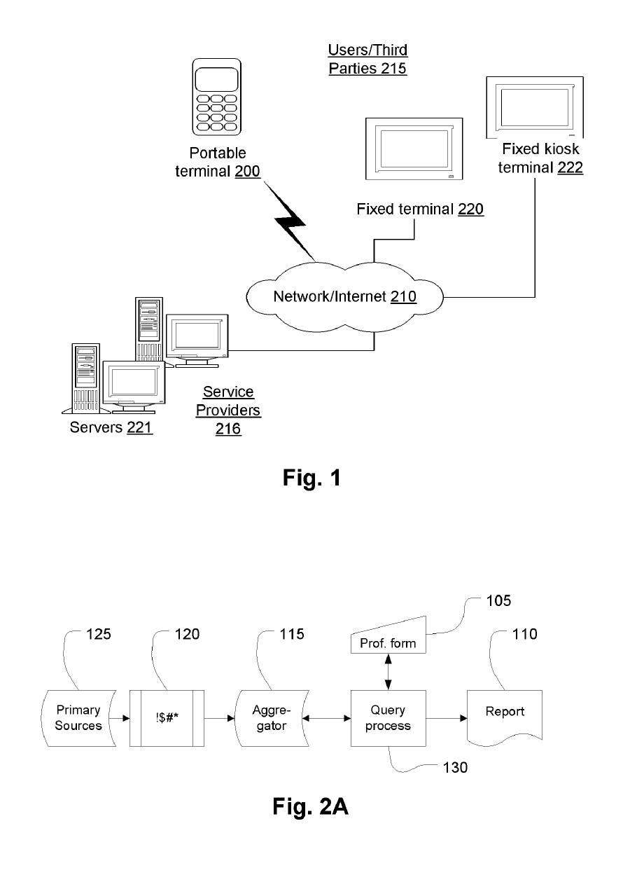

FIG. 1 illustrates a network or Internetwork architecture for implementing various features of the present inventive embodiments. The inventive embodiments concern reports of information from content databases, for example public records of interest to the subjects of the reports, for example, individual consumers. Examples of public records include credit profile data, criminal convictions, financial records such as bankruptcy, and property ownership records. A user 215 may request information from one or more service providers 216 through a wireless 200, or fixed 220, 222 terminal. The request may be entered in a form, for example an html form generated by a server 221 and transmitted to the terminal 200, 220, 222 via a network, internetwork, and/or the Internet 210. Data submitted by the user (or interested third party, assuming the subject of the data is said user) 215 may be transmitted from the terminal 200, 220, 222 via a network, internetwork, and/or the Internet 210 to the server 221 (which may be the same or a different server or servers) and used to generate a query. The query may be generated on one server 221 and transmitted, via network, internetwork, and/or the Internet 210, to another server 221 and in response data obtained as a result of the query and also transmitted, via a network, internetwork, and/or the Internet 210, to the user or third party 215 at a corresponding terminal 200, 220, 222 or some other location, for example a permanent or semi-permanent data store for future access (not shown separately but structurally the same as servers 221). The network, internetwork, and/or the Internet 210 may include further servers, routers, switches and other hardware according to known principles, engineering requirements, and designer choices.

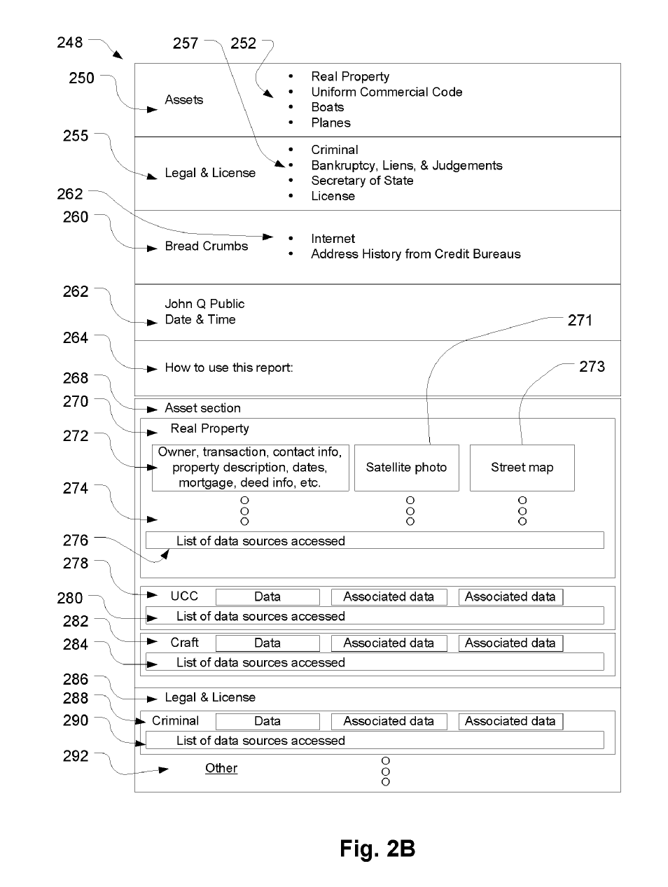

FIG. 2A an embodiment in which a public information profile report may be generated from a secondary source, such as a data aggregator. The arrows illustrate data exchange processes which are described in the text. The entities represent computers, servers, and data transfers may occur through networks or internetworks, such as the Internet using any appropriate known protocols. Multiple primary sources 125 of information are queried by the owner of one or more secondary sources 115 to aggregate the contents of the primary sources and make the data available to customers of the owners of the secondary sources (not shown). For example, the secondary sources 115 may include identification and credential verification service or credit bureaus. Secondary sources 115 may provide rapid and complex searches by subscribers. For example, entities such as government offices, the FBI, prospective employers, etc. may subscribe to services of the secondary source 115 providers to do background checks on individuals of concern to the entities. Such individuals may include job applicants, proposed business contacts, constituents, criminal suspects, opposing political candidates, etc. These entities may also obtain information directly from primary sources 115, described below.

When a secondary source 115 obtains data from primary sources 125, the data may suffer any of a variety of changes, such as data corruption, transcription errors, deliberate data manipulation, etc. These may occur in a process of data transfer from the primary source 125 or within the secondary source 115. These changes are represented figuratively by the operator 120. A Public Information Profile (PIP) service which has subscribers who are individuals concerned about their own personal information and misinformation which may be available through the secondary 115 or primary 125 sources may obtain data directly from the primary 125 and/or secondary 115 sources and compile a report 110. The report contains all information generated from the primary 125 and/or secondary 115 sources resulting from a query generated by a query process 130 which uses information from a profile form 105 providing data about a user.

Examples of primary and secondary sources 115 and 125 include: Property ownership records, real estate records, Government-issued and other organization and professional licenses and registrations and professional and educational certifications, degrees, etc. These might be found government, employer's or other entity's background information store. Law enforcement records on felony and misdemeanor convictions. Criminal records and special offender (e.g. sex-offender) registered lists. These include criminal convictions—including misdemeanors and felonies. These records might be found in a government, employer's or other entity's background check. Financial records like bankruptcy, liens, judgments: These include bankruptcies, liens, and judgments awarded against an individual or individuals. These records might be found in a government, employer's or other entity's background check. PACER: Public Access to Court Electronic Records (PACER) is an electronic service that gives case information from Federal Appellate, Federal District and Federal Bankruptcy courts. UCC (Uniform Commercial Code) records that reveal the availability of assets for attachment or seizure, and the financial relationship between an individual and other entities. These include public notices filed by a person's creditors to determine the assets available for liens or seizure. Secretary of State: including corporate filings identified by the names of agents/officers. An example of a web site offering such information is NY's department of state web site located at: http://www.dos.state.ny.us/Internet search: matches from databases that may match or cite your name or names similar to yours, from Web search engines, usenet newsgroups, or any other Internet-accessible resource. Personal Details: matches from databases that are associated with your name or names similar to yours, your past or present address and telephone, your SSN, your relatives, or even people that you have been associated with. Insurance claims databases, such as CLUE, which store information about insurance claims made by individuals and organizations. Credit Header Data: the addresses associated with your Social Security Number and name in credit reports. The address history in your PIP can be 10-20 years old. These records might be found in a government, employer's or other entity's background check. HUD: Department of Housing and Urban Development (HUD) or Federal Housing Administration (FHA) insured mortgage, subject may be eligible for a refund of part of your insurance premium or a share of any excess earnings from the FHA's Mutual Mortgage Insurance Fund. HUD searches for unpaid refunds by name. PBGC: Pension Benefit Guaranty Corporation, collects insurance premiums from employers that sponsor insured pension plans, earns money from investments and receives funds from pension plans it takes over. Financial and credit data as provided by the three major credit bureaus. Census data Voting records Telephone disconnects and other telephone company data United States Postal Service Coding Accuracy Support System (CASS) is an address correction system which compares an address to the last address on file at the USPS for the recipient. Email databases. Other Fraud Databases, such as maintained by data aggregators, that associate identifiers, such as a particular physical address, with known risk of fraud. Telemarketing and Direct Mail Marketing databases. Retailer databases including customer loyalty databases, demographic databases, personal and group purchasing information, etc. Warranty registration databases.

In the embodiment of FIG. 2A, data is preferably derived from the secondary source or sources 115 to allow the report 110 (e.g., a PIP) to be generated quickly and consistently. This is because the primary sources 125 can be numerous and diffuse; that is, they may be scattered at many different locations and in various states of accessibility. If one were to rely on the primary sources 125, the report 105 would take longer and it would be inconsistent in terms of scope because the unavailability of certain databases. However preferable, the inventive embodiments are not limited to querying only a secondary (aggregator) source. In addition, the secondary source or sources 115 may or may not include content aggregators. They may include content enhancers, i.e., ones which take data from a single source, but which enhance it in some way, for example by holding data for longer periods of time, making data from primary sources 125 which is ephemeral, more permanent.

Where various sources contain identical primary information, the elements of this information may be juxtaposed in the PIP for comparison. For example, the PIP may highlight those information elements that contain identical information. The sameness of the data may be determined based on the information itself or from descriptive information from the data source. For example, an address record may contains the same address with different valuations of the price paid for the property on a particular date. The discrepancy may be highlighted in the report by lining up the identical records, such as in adjacent rows of a table with the corresponding elements aligned in columns. In this way discrepancies in the data may be discerned easily by the user.

In terms of a method, a user authenticates himself by logging into the query process 130 which has generated a form 105. The form accepts data from the user identifying him and this data is used by the query process 130 to generate a query of the secondary source 115. The identifying data accepted by the form may include authentication information that includes private information that the user would normally keep secret, such as his social security number. The query process 130 may use discrepancies in the data as a basis for rejecting the request for a PIP by generating an appropriate user interface element such as a dialog box. The secondary source 115 generates a set of data from the query by filtering and sorting its internal database and transmits them to the query process 130 which then formats and adds additional data (described below) to generate the report 10. An element of the method is content aggregation performed by the secondary source 115 in which data is regularly obtained by an internal query process (not shown) is applied to the primary sources 125 to obtain comprehensive compilations of data which are stored by the secondary source 115.

FIG. 2B illustrates an example of a public information profile (PIP) report which may be generated according to inventive embodiments described in FIG. 2A and elsewhere in the specification. A navigation header 248 includes categorical areas 250, 255, and 262 which may be hyperlinked, with subcategory links 252, 257, and 262. Categorical areas 250, 255, and 262 represent assets, legal and license records, and bread crumbs, respectively. The meanings of the categories should be apparent from the text subcategory links 252, 257, and 262 shown in the drawing and from the details illustrated further on. The bread crumbs area is for information that can be compiled from various sources that represent random information relating to the user, for example, it may be such as an Internet search on the user's name or other identifier would provide.

Area 262 is a summary header providing identifier information about the user who is the subject of the report, a summary of the results, and date and time information or other information that qualifies the report. The summary of the results may include subject matter categories 294 . . . 296 with corresponding results 295 . . . 299 and corresponding explanations 297 . . . 298. The categories 294 . . . 296 may follow the categories 250, 255, 260 and/or subcategories 252, 257, 262 described below. The results 295 . . . 299 may simply indicate the number of positive hits (records associated with the user) found within each category. Respective explanations 297 . . . 298 may indicate what search criteria produced any positive hits or may summarize all of the criteria which were tried. For example, it may recite as follows:

5 properties found based on SSN, in MD, NY, & VA. 1 additional found based on “John Public” in VT. Tried SSN, “John Quincy Public;” “John Q Public;” and “John Public” in all sources listed in summary section.

0 properties found based on SSN, “John Quincy Public;” “John Q Public;” and “John Public” in all sources listed in summary section.

where “SSN” stands for social security number.

The summary header 262 may also include information about limits placed on the content of the report, who is authorized to read it, etc. Area 264 indicates a blurb or a link to the same to describe in summary fashion how to use the report, what its limits are, and what to do about misinformation appearing in the report.

Area 268 is the asset category section and it includes the section 270, which is the first section delivering results from a search. This section 270 is a real property report and includes subsection 272 which describes information about the first property, such as transaction data, property description, mortgage companies, parties involved in the transaction, etc. The section 272 may accompanied by graphics such as a satellite photo 271 and street map 273 of the property and surrounding area. Also illustrated is a citation/criteria block 277 indicating the particular source of each item of information and what criteria produced the positive result. The citation/criteria block 277 may be provided on a record by record or field by field basis. It may indicate a category of the secondary source 115 or a particular primary source 125 or category (part of the source database) from which the associated data item originated. Other items such as assessed value, values for comparables in the neighborhood, etc. may also be provided. The ellipses at 274 indicate that many records may follow as appropriate. After the record data, at 276, the list of sources searched may be indicated. The list of sources 276 may identify primary sources 125 or secondary sources 115 or portions thereof, whether the data was derived through the primary or secondary source. For example, the secondary source 115 may identify the primary source from which a datum was originally obtained by the secondary source 115. This original source information may be passed through the secondary source 115 and the data attributed to the primary source even though, for purposes of generating the report, it was derived from the secondary source 115.

One of the important pieces of information included in a PIP is what it does not show, that is, the lack any hits after a particular database is searched. A consumer may be just as interested in a failure of the PIP to show a record as in a record showing up which is either wrong or should not be identified with the user. Thus, the list of data sources accessed is a useful component of the report and may therefore be included in the body of the PIP.

Further sections and records such as the UCC report area 278, Craft report area 282 to show records such as for planes and boats registered to the user, legal and license area 286 with criminal records 288 may include corresponding lists of data sources 280, 284, and 290. Further records grouped by category and listed as indicated in the navigation header 248 may be shown as suggested by the ellipses 282.

The entire report of FIG. 2B may be delivered as a digital document, a printed document, or an html page or any other means. It may be encoded on a smart card or other portable data store. Authentication information may be included in the report, for example, a hologram seal on a printed report, to provide some verification capability that the report is true to the information and reporting done by the service associated with system FIG. 2A.

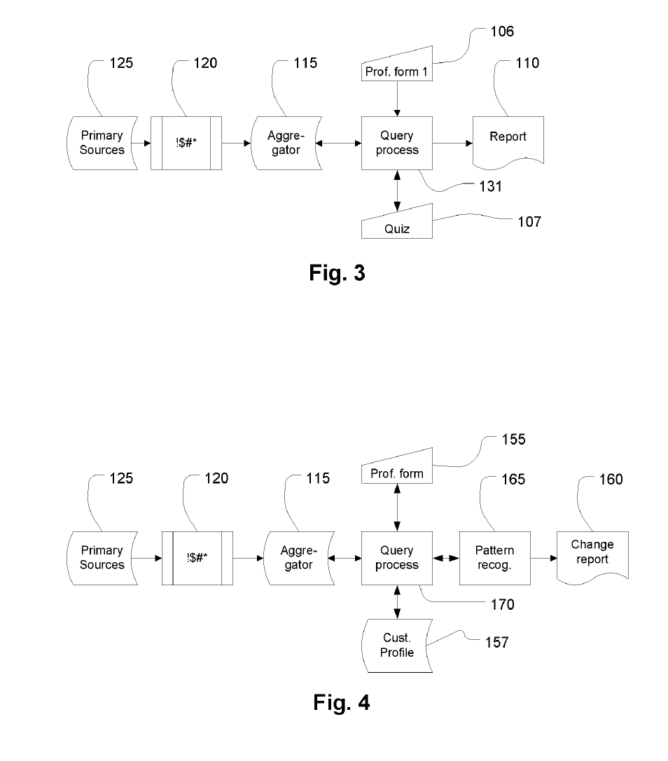

FIG. 3 shows an embodiment in which feedback is obtained to further confirm the identity of a user. Here, as in further embodiments, like numerals indicate similar or identical components and are not redundantly described for that reason. In this embodiment, after identification/authentication information is obtained through the form 106, the query process 131 calls up information from the secondary source 115 and creates a quiz. The quiz tests the identity of the user by asking questions about information the user would likely know but someone other than the person would not. This guards against someone benefiting from finding or stealing the user's wallet or other personal effects containing personal information. For example, the quiz may ask the user to indicate which of a list of addresses was a former residence of the user. The question can be generated as a multiple choice question with “none of the above” being a choice, to make it more difficult. Other kinds of questions can be based on the identity of a mortgage company, criminal records, or any of the information the system accesses. The query process 131 may employ predefined rules for the purpose of generating the quiz. For example, the process 131 may rely on a randomized selection of data such as mortgage company, old addresses, previous employers, locations where craft were registered and what kind, size of houses previously owned, etc. The query process 131 may further rely on the effectiveness of candidate discriminators to distinguish among possible users, for example, by doing a search on individuals similar to the person identified by the identification/authentication information and then basing questions on what makes each unique compared to the others. This is a more flexible approach and can be implemented using a simple frequency filter that identifies the questions whose answers are least likely to be shared by two or more in the search result of similar individuals.

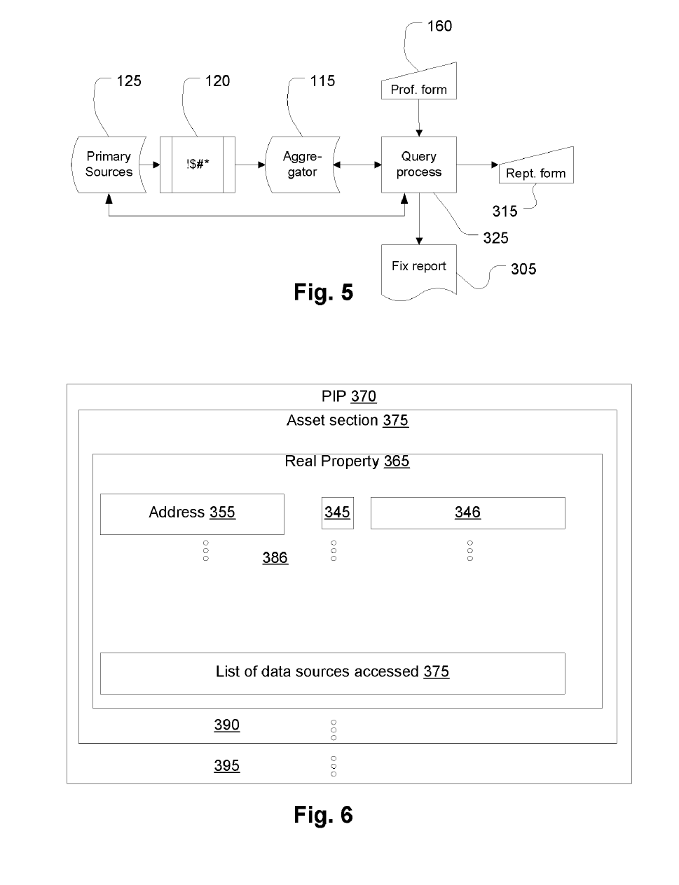

FIG. 4 illustrates an embodiment in which a change report is generated from a user profile and a public information database. The process and system represented by FIG. 4 is similar to that of FIG. 2A, except that after the query process 170 authenticates the user and generates and transmits a PIP, at least some parts of the PIP are stored in a profile 157 associated with the particular user. Then, periodically, the query process 170 queries the secondary source 115 and compares the resulting filtered set of data to the data stored in the profile 157. To do so, the query process 170 may follow a pattern recognition process 165 to identify certain kinds of changes. For example, the pattern recognition process 165 may be trained to identify traces of fraudulent actions. These patterns may be diffuse, such as certain kinds of monetary withdrawals that look like someone trying to hide under the radar or focused such as the registration of a vehicle in a state in which the user has no previous ties. When the pattern recognition process 165 identifies one or more events of interest, it may generate a notification to the user, such as by SMS messaging or email and provide access to a report providing details of the event(s) that triggered the notice, as represented by change report 160. Note that similar pattern recognition processes may be used to identify noteworthy patterns or trends in the PIP as well as to generate change reports, as described further with reference to FIG. 5.

FIG. 5 illustrates a system and method for generating an augmented public information profile report in which questionable information is fixed and/or annotated. A profile form 105 is filled out by the user as in the embodiment of FIG. 1A and a query process 325 generates a report form 315 which contains a PIP with a form for feedback. The form may be integrated into the PIP, for example form controls in an html-delivered PIP format. The report form 315 is designed to allow the user to indicate questionable items in the PIP. For example, each data item may be provided with a check box or set of radio buttons to indicate that the data item is believed to be wrong for some reason. The report form 315 may include multiple iterations (a second html page, for example, in response to the user submitting the first form) to request further information about the supposed errors. For example, the second form 315 may ask whether an address that was flagged by the user in the first form 315 was the wrong address or contains a typo. The first form may include controls to allow the user to indicate that a data item is missing, for example, an old paid up mortgage is not listed.

When the query process 325 receives the form 315 and any further iterations of it, it generates one or more queries of the primary sources 125 associated with the data that were indicated as erroneous or incomplete. The box labeled primary sources 125 may be viewed as encapsulating any access devices such as a web-interface to allow queries to be satisfied. Many governmental organizations provide such services for free. But a manual search may also need to be done. With the additional data from the primary source, the query process 325 generates a new fix report 305 that contains both the secondary source data and the primary source data, preferably in juxtaposition for comparison. The fix report may contain only the flagged data items or it may be a complete PIP with the additional information shown. Preferably, in a complete PIP, the verified data items are highlighted, such as by using a colored background.

Information indicating noteworthy or otherwise significant information can be derived by making comparisons and/or detecting patterns in data from multiple sources such as:
Comparing data from a database with lesser authority with one with a greater authority such as comparing a secondary source with a primary source, to determine if a source may be wrong.
Looking for inconsistencies among data, including direct inconsistencies (such as above) and indirect inconsistencies. An example of this is where the demographics of user are inconsistent with recent purchasing patterns. E.g., a young accountant with a family purchases aftermarket auto parts at a bricks and mortar retailer far from the user's home address. For another example, if certain data tend to change at the same times: the telephone database should indicate that a user's phone number has changed when the address changes, for example, and when it hasn't it's something that should be flagged in the PIP, change report, and/or alert. Yet another example is where different primary and secondary credit or merchant databases show instances when a “most recent” address for a name (with or without an Social Security Number and other identifiers) does not match from one data source to the next.
Structural defects in data such as failure of uniqueness, such as more than one name associated with a Social Security Number or similar clusters of information that would indicate multiple instances of a an individual, for example identical name and age living at a single address at one time, but residing at more than one address at another time.
Identifying data held by entities with known past instances of fraud such as massive theft of loss of information. Additionally, data storage entities that are popular targets of data theft or known to be vulnerable to data theft. For example, a large multinational bank may be a more common target for hackers than one with a purely local presence and difficult to access extraterritorially.
   Classifying data associated with a user according to known patterns of fraud liability. For example, demographic data of a user may, statistically, be associated with a higher incidence of fraud, for example addresses. This could happen where the trash of wealthy residents is a known target of dumpster divers looking for sensitive documents that have put in the trash. Classification can be constructed using known collaborative filtering techniques, based on diverse sources of information even as divergent as voting records and census data. Although such records may not be updated frequently they can be used to generate classifications for users that are persistent. Data classification may be fuzzy in nature, and not a black and white indicator. For example, an examination of cell phone databases might indicate that a unique individual has more than one cell phone. While not a indicator of fraud by itself, it is noteworthy and, if combined with other information, it may provide a strong indicator of fraud or identity confusion problems.

FIG. 6 shows a complete PIP 370 illustrating an embodiment of the report form 315. A check box control 345 is shown as an example in the Asset section's real property section 365 adjacent an address 355. Also shown is a text box control 346 for the user to enter a comment about the particular piece of data, here, the address in this example. A user may check the check box and enter text in the text box control 346 and submit the form 315 which is then processed by the query process 325. Other records and other information are indicated elliptically at 386, 390, and 395 including data sources accessed 375. The embodiment of the PIP 370 may be implemented as an html form so that it serves as both a report and form.

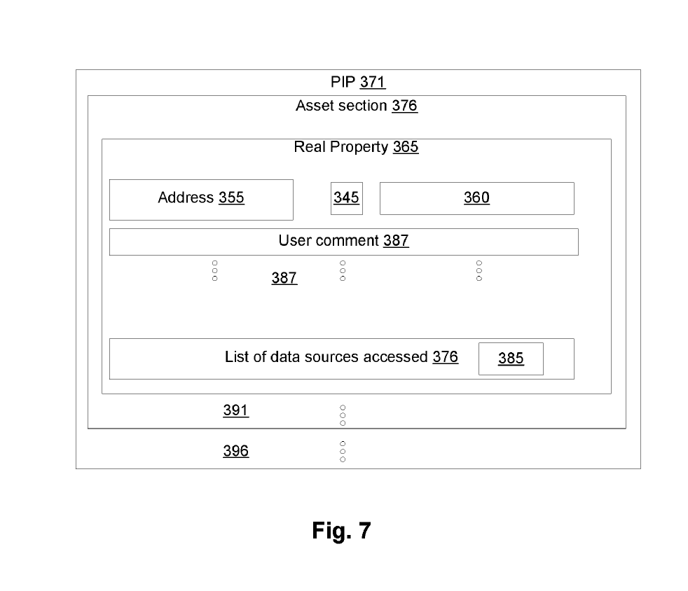

FIG. 7 shows a complete PIP 371 illustrating an embodiment of the fix report 305. As in the previous embodiment, it contains an asset section 376 with a real property section 366 with address information 355 of the report form 315 embodiment. Juxtaposed with address information 355 is address information 360, which originates from the search of the primary sources 125. The user's comment 397 also appears in a manner that associates it with the information that was questioned. In addition to a Highlighting 380 may indicate that information in the PIP 371 includes information that is revised, for example as shown here, the address information 355 and 360 are highlighted 380 to indicate that the additional address information 360 has been provided. Also, the additional source of information 385; i.e., a direct query of the original source, may be shown in the sources listing 376.

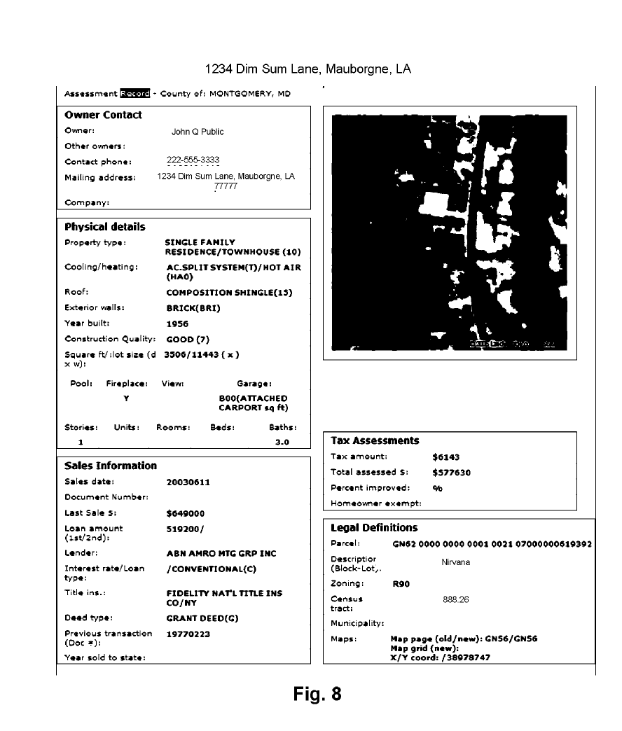

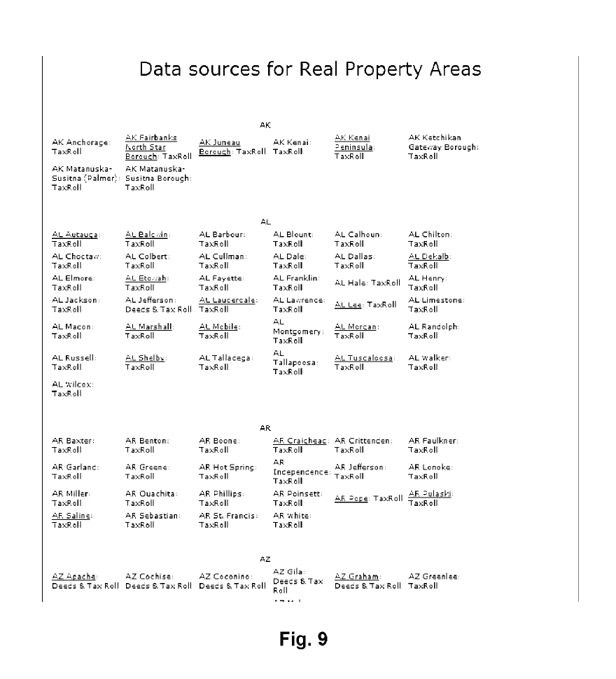

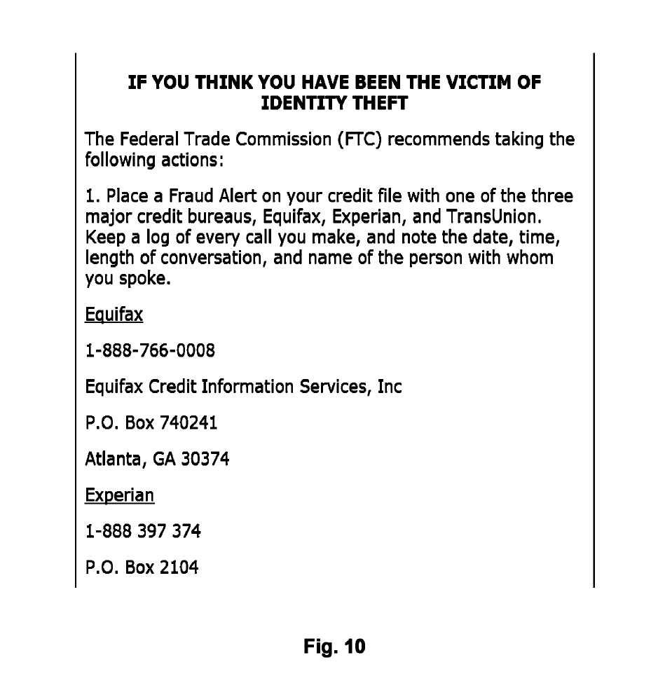

FIG. 8 shows a portion of a PIP embodiment relating to real estate residences purchased. This is a snapshot of what might appear in section 270 in the PIP 248 illustrated and discussed with respect to FIG. 2B. FIG. 9 illustrates a portion of an embodiment of a list of data sources accessed. This is also a snapshot of what might appear in section, for example 276 or 284, in the PIP 248 illustrated and discussed with respect to FIG. 2B. FIG. 10 illustrates helpful information (e.g., as indicated at 292 in FIG. 2B) that may be included in a PIP.

FIG. 9 illustrates a portion of an embodiment of a list of data sources accessed. This may be provided as part of the PIP or in a separate document. It shows all data sources grouped and ordered by region for each category of data. For example, the illustrated one is a portion representing data sources for real estate information.

FIG. 10 illustrates other information that may be included in a PIP including instructions for what to do if certain kinds of false or misleading data are identified automatically or by the user. For example, as shown, contact information to allow the user to file a credit freeze with the three major credit bureaus may be provided. Other information and web controls may also be provided as described elsewhere in the present specification. Preferably such information is shown in the PIP itself with web navigation controls to make a long report convenient to review.

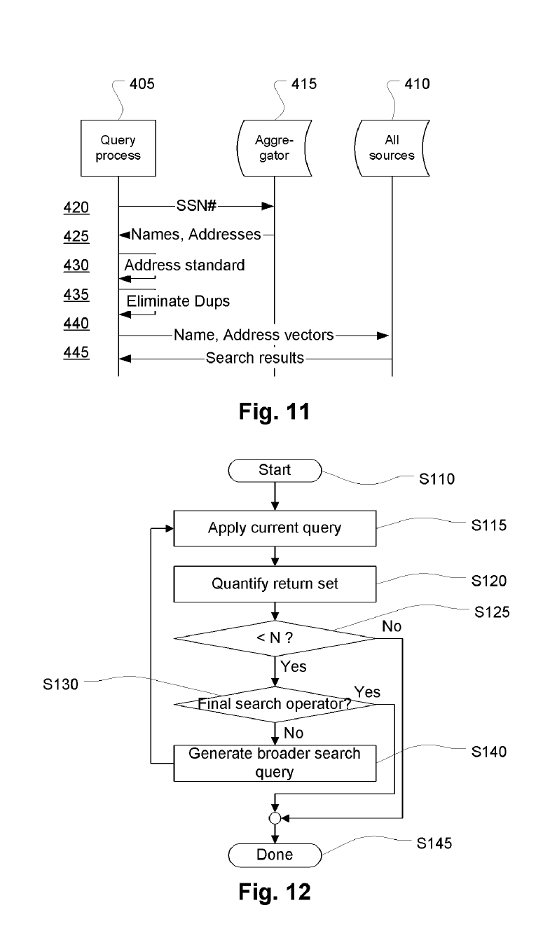

FIG. 11 shows an example process for searching a database in which the search query is made broader by an iterative process that derives alternative search criteria. A query process 405 generates a query as indicated at 420, for example, one including only a social security number to search a first database 415, in the present example one provided by an aggregator 415 of diverse primary data sources. The result of the first query is further information connected to the social security number. In the example shown, the further information includes names and addresses as indicated at 425. These may include a variety of names and addresses if the name has been misspelled, was changed, or a number of formats are used. The addresses and names may be run through a standardization process of filter 430 to conform the names and addresses to a standardized format to make essentially identical addresses appear the same. For example, the post office provides such a filter for addresses. The duplicates are then eliminated in the list of names and addresses as indicated at 435 and the resulting list used as alternative query vectors for searching all the searched databases, including primary and secondary sources 410. The search results are then obtained as indicated at 445.

Note that the embodiment of FIG. 11 is not limited to names and addresses. Other kinds of search vectors may be used, such as driver's license number, biometric data, etc. Also, the filtering and duplication-elimination processes may be eliminated or altered to allow for misspellings in the records of the databases. The aim of the process of FIG. 11 is to obtain all the possible records associated with the user. Also, although the process is illustrated as querying an aggregator database with a first query and then querying other sources 4T0, it is possible to query primary sources and then aggregator sources of information or primary first and then, based on the result, aggregator databases.

FIG. 12 shows a process related to that of FIG. 11 for iteratively broadening search criteria until a target goal number of records is reached. At a first step S115 after starting the process S110, a current, initially narrow (strict), query is used to search a data set. A return set is obtained and the number of records counted at step S120. The number is compared with a goal N at step S125 and if it is lower than the goal it is determined if the search can be broadened (made less strict) at step S130. If so, a broader search query is generated at step S140. If not, the process terminates. Also, if at step S125 it is determined that the goal number of records has been obtained, the process is also ended S145. An example number for N is 30. Note that the number N may not be a strict cutoff such that if the number of records returned using a relaxed criterion exceeds N but is close to it, while the stricter criterion produces a very low number or none, the result obtained from the relaxed criterion may be used. It is preferred thus, that no records be excluded on arbitrary grounds to satisfy a numerical requirement. Also, more than one database may be queried in the process of FIG. 12. For example, rather than expanding the query, the process may include querying other databases which may contain, for example, less preferred data, in an effort to reach the goal number of records. This could include or replace in step S140, linking to another database such that the group of databases queries is iteratively expanded until N is reached.

The goal number of records N may or may not be a fixed parameter for all users in all instances of use. For example, N could be based on how common the user's surname or first name is. This could be determined via a lookup table of names. In addition, the process need not be literally as illustrated. Many algorithms for achieving the result of a target number of records may be employed, for example starting with a moderately narrow query and iterating toward the goal from a level that is too high or too low. Examples of broad and narrow queries can be generated from partial information, such as last name plus first initial, or addresses that include street name without the street number. In addition, or alternatively, the queries could include misspelled alternatives or other kinds of fuzzy search strategies. The alternative strategies may include retrieving a maximum data set in a single query and reducing the number of records based on the narrow and broad query criteria in a local process. In that way, the external database only has to be queried once and the retrieved dataset can be efficiently sorted and prioritized using the narrow-to-broad query criteria.

FIG. 13 shows an embodiment of a portion of a public information profile (PIP) which summarizes the contents obtained. The portion, a header and navigation area 500 of a web page, for example, generated dynamically from the search result, includes a print control 515. Each of multiple sections, for example one indicated by a category label 530, correspond to a category of information returned by the search. Indicated alongside the category label 530 is a phrase (e.g., such as at 510) indicating the number of records found and information about the search, for example, the criteria used in the query. In the first example indicated at 510 16 addresses were found in the address history search by matching against social security number. A control to view the results is indicated alongside the portion 530 at 520. Other examples of criteria are indicated at 535 and 540. A header part 505 identifies the subject of the PIP. The header 500 may appear at the top of a long report which may appear as a single web page that is dynamically generated.

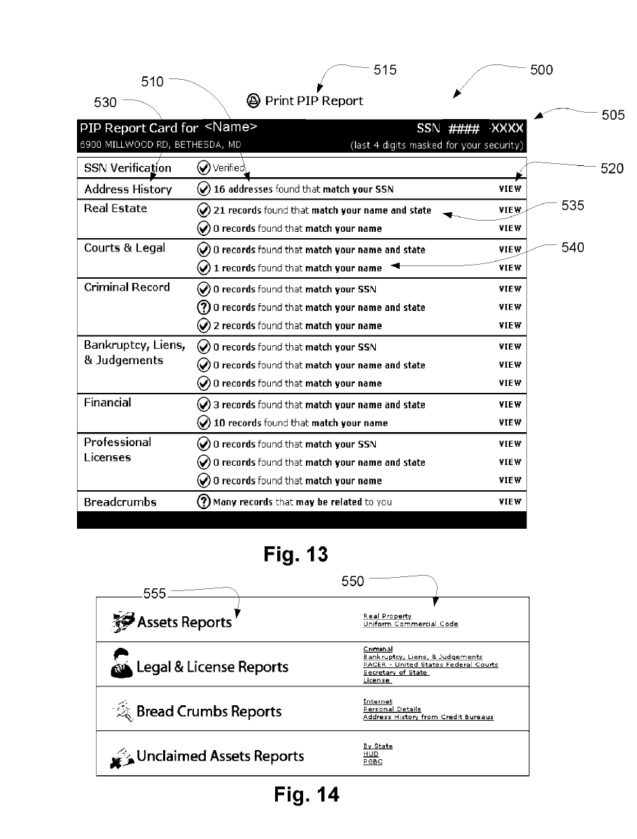

FIG. 14 shows an embodiment of a portion of a public information profile (PIP) which provides links to different portions of the PIP. This is an example of a navigation control in which all the different sections are grouped by a broader category such as indicated by the label 555. For each broader category, a link (such as indicated at 550) for the portions of the report corresponding to each of a number of narrower categories are also provided. Preferably this navigation tool is shown at the top and links provided to it (or it is duplicated) at various parts of the report, which in practice, could be very long.

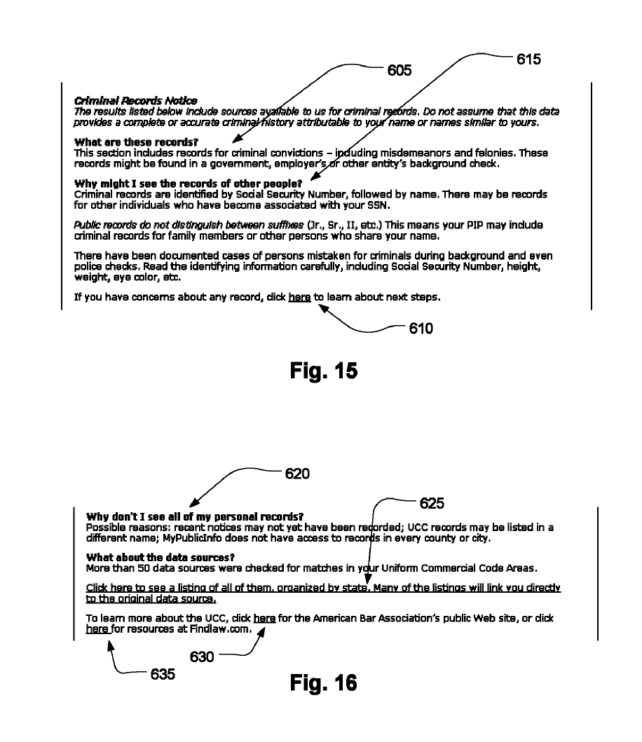

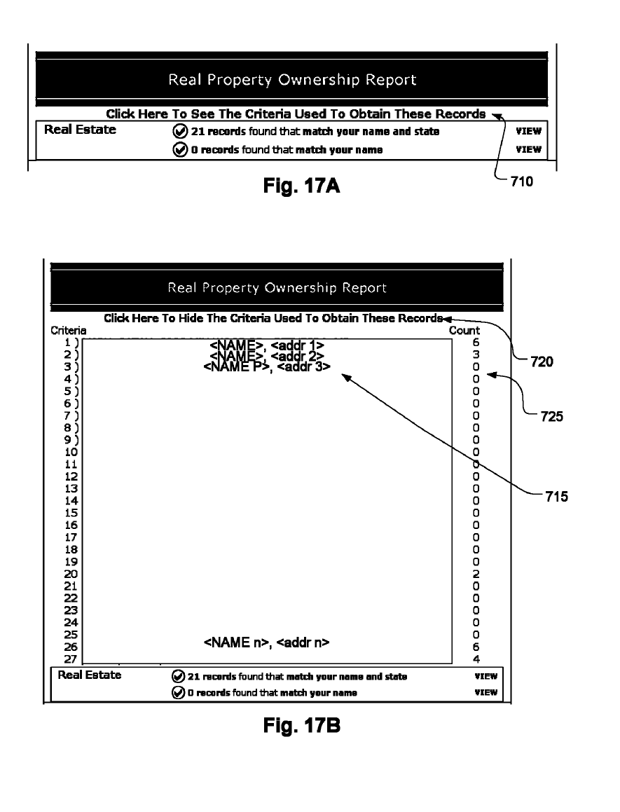

FIG. 15 shows an embodiment of a portion of a public information profile (PIP) which provides information and link controls for assistance regarding certain elements of the PIP. For each section of the report, various pieces of relevant information may be provided such as indicated (and self-explained) at 605, 615, and 610. In a preferred embodiment, a more detailed explanation of the nature of the records is shown in the corresponding section close to the corresponding group of records. This is a navigation expedient; namely, distributing the key relevant descriptions among the records in the report. Description and other information which are deemed key in the preferred embodiment are a detailed explanation of what the records are, where they come from, and why the records may include unexpected results. A short FAQ may appear in this same location. Similarly adjacent each record group, as in FIG. 16, information and link controls for assistance, such as indicated (and self-explained) at 620, 625, 630, and 635, regarding certain elements of the PIP may include an expandable list of data sources, or as indicated in FIGS. 17A and 17B an expandable list of criteria used to generate the search results may also be provided. Although it is preferred that this information and these controls be distributed in the report as shown, in alternative embodiments they may be provided in a single location in the report or on a separate page, which may be programmed to open in a separate browser window or browser tab.

FIGS. 17A and 17B show collapsed and expanded views of criteria used to show records obtained (a similar embodiment may be included as well to show information about the sources of the information). FIG. 17A shows the list of criteria in an unexpanded state and 17B in an expanded state. The features are indicated (and self-explained) at 710, 720, 725, 715. The criteria 715, as discussed above, may include various alternatives of similar (overlapping) information such different references to the same address and the count of results. Queries that produce negative results are also shown by the column of records returned counts indicated at 725.

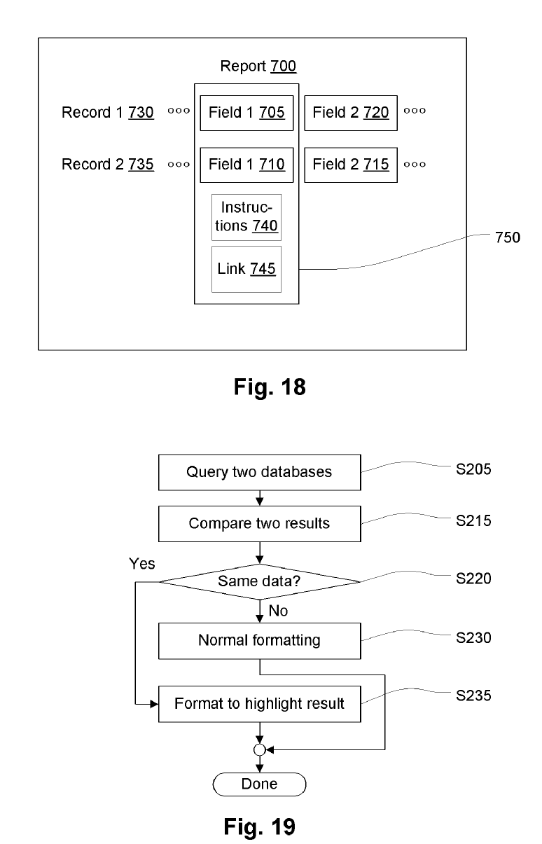

FIGS. 18 and 19 illustrate a PIP format feature that helps users understand when discrepancies may arise between one or more data sources and how to cure them. In FIG. 18, a report (PIP) 7000 contains two records, each determined to pertain to the same person, event, or thing. For example, both can represent the same house. However, the records are not identical in content and contain contradictory information, such as who the owner was or whether a lien exists on the property. The contradictory information, indicated as Field 1 705 and Field 1 710 are formatted so that they are juxtaposed for easy comparison. To further highlight the contradiction, a highlight 750 is added such as a colored box, a border, or some other means. Also included is an instruction for responding to the discrepancy indicated at step 740 and a link to a site with further information for responding or further information about the problem, indicated at 745. Note that discrepancies can be shown without special formatting just by including otherwise identical records in the PIP.

Discrepancies can arise for example where a data aggregator makes a transcription error when copying information from a primary source. Also, when a record is not updated after a change of status, for example the title is not changed after the sale of a fractional interest in a house to a remaining spouse following a divorce. In FIG. 19, a process for identifying similar information and formatting the results for easy comparison is shown. In step S205 two databases containing information pertaining to a same person, event, or thing are queried and the results compared at step S215. At step S220, it is determined if information in the records pertains to the same person, event, or thing. For example, if the information relates to an address, the addresses are compared to see if they are the same or similar. Then, at step S230, if the comparison indicates the results pertain to the same person, event, or thing, normal formatting is applied at step S230 and in the alternative case, special formatting is applied at step S235. The latter may include the addition of instructions and/or links as discussed with reference to FIG. 18.

Although the present invention has been described herein with reference to a specific preferred embodiment, many modifications and variations therein will be readily occur to those skilled in the art. Accordingly, all such variations and modifications are included within the intended scope of the present invention as defined by the following claims.

1. A method of providing a report of public information, relating to an individual, to that individual, comprising:
from at least a network server, transmitting a form with fields for obtaining identifying information, identifying said individual, to a client terminal;
receiving at at least a network server from said client terminal, identifying information associated with said form fields, said identifying information substantially uniquely identifying said individual;
at at least a network server, authenticating a requester at said client terminal to confirm that said requester is said individual;
at at least a network server, querying a database with a first query based on part of said identifying information and retrieving a result;
said result containing at least two pieces of information about an individual;
deriving a second query from said at least two pieces of information and querying said database and/or another database using said second query;
retrieving a result of said second querying;
generating a report with said results of said second querying, said results including at least real estate records.

2. A method as in claim 1, wherein said first query includes a social security number.

3. A method as in claim 1, wherein said second query includes at least a name of said individual and at least two addresses, said second query being effective to retrieve results corresponding to both of said at least two.

4. A method as in claim 1, wherein said result of said first step of querying includes addresses, said second query includes addresses, and said method further comprises a step of filtering out redundant addresses such that said second query contains non-redundant addresses.

5. A method of providing a report of public information, relating to an individual, to that individual, comprising:
from at least a network server, transmitting a form with fields for obtaining identifying information, identifying said individual, to a client terminal;
receiving at at least a network server from said client terminal, identifying information including a social security number;
at at least a network server, authenticating a requester at said client terminal to confirm that said requester is said individual;
at at least a network server, querying a first database with a first query including said social security number and retrieving at least two addresses corresponding to said individual;
at least reducing a number of redundancies among said at least two addresses and generating a second query including non-redundant addresses such that records retrieved by said second query include records pertaining to all non-redundant addresses, performing a query with said second query and retrieving a second result;
generating a report with said results of said second result, said second result including at least real estate records.

6. A method as in claim 5, wherein said step of eliminating includes converting all said at least two addresses containing different formats to a standard address format.

7. A method as in claim 5, wherein said step of querying a first database includes querying an aggregator database.

8. A method as in claim 5, wherein said first step of querying includes querying an aggregator database including records from multiple primary databases and said step of performing a query includes querying at least one of said primary databases.

9. A method as in claim 5, wherein said first step of querying includes querying at least one of an aggregator database, including records from multiple primary databases and at least one of said primary databases, and said step of performing a query includes querying at least said aggregator database.

10. A method as in claim 5, wherein said step of querying a first database includes querying an aggregator database and said step of performing a query includes recursively querying said aggregator database.

11. A method of providing a report of public information, relating to an individual, to that individual, comprising:
from at least a network server, transmitting a form with fields for obtaining identifying information, identifying said individual, to a client terminal;
receiving at at least a network server from said client terminal, identifying information associated with said form fields, said identifying information substantially uniquely identifying said individual;
at at least a network server, authenticating a requester at said client terminal to confirm that said requester is said individual;
at at least a network server, querying a database with a first query based on part of said identifying information and retrieving a result;
said result containing at least one piece of information about an individual;
deriving a second query from said at least two pieces at least one piece of information and querying said database and/or another database using said second query;
retrieving a result of said second querying;
generating a report with said results of said second querying, said results including at least real estate records.

12. A method as in claim 11, wherein said first query includes a social security number.

13. A method as in claim I 1, wherein said second query includes at least a name of said individual and at least two addresses, said at least one piece of information being at least two pieces of information, said second query being effective to retrieve results corresponding to both of said at least two.

14. A method as in claim 11, wherein said result of said first step of querying includes addresses, said second query includes addresses, and said method further comprises a step of filtering out redundant addresses such that said second query contains non-redundant addresses.

15. The method of claim 1, further comprising, performing the generating responsively contingent on a result of the authenticating by preventing a requester other than one identified by the identifying information from generating the report.

16. The method of claim 1, wherein the authenticating includes generating a quiz and receiving further information in response to the quiz, the quiz containing questions regarding information pertaining to the person identified in the identifying information.

17. The method of claim 1, wherein the at least two real estate records includes at least satellite image.
